(19) United States
(12) Patent Application Publication
(10) Pub. No.: US 2024/0051599 A1
(43) Pub. Date: Feb. 15, 2024

(54) A DUAL MOTOR DRIVE ASSEMBLY

(71) Applicant: ZF Automotive UK Limited, Solihull (GB)

(72) Inventors: Russell Wilson-Jones, Stratford upon Avon (GB); Mark Anthony Wilkes, Kings Norton (GB); Aleksejs Semjonovs, Snohomish, WA (US)

(21) Appl. No.: 18/362,450

(22) Filed: Jul. 31, 2023

(30) Foreign Application Priority Data
Aug. 9, 2022 (GB) 2211650.3

(51) Int. Cl. B62D 5/04; B62D 1/20; B62D 6/00

(52) U.S. Cl. CPC B62D 5/0463; B62D 1/20; B62D 6/008

(57) ABSTRACT

A dual motor drive assembly can include a housing, a shaft rotatably mounted with respect to the housing, a first gear connected to and configured to rotate with the shaft, first and second motors, each having an output driving a respective output gear, the output gears being engaged with the first gear. The dual motor drive assembly can also include a control circuit which is adapted to allocate independent torque demands to each of the first and second motors to cause a net torque to be applied to the shaft.

### CROSS-REFERENCE TO RELATED APPLICATION

This application claims priority to GB Priority Application No. 2211650.3, filed Aug. 9, 2022, the disclosure of which is incorporated herein by reference in its entirety.

### TECHNICAL FIELD

This disclosure relates to a dual motor drive assembly, in particular but not exclusively suitable for use in a handwheel actuator (HWA) assembly of a vehicle.

### BACKGROUND

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications in in steer-by-wire systems. During normal use, these systems have no direct mechanical link from the hand wheel that the driver moves and the steered wheels with movement of the hand wheel by the driver being detected by a sensor and the motor being driven in response to the output of the sensor to generate a force that steers the road wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary electric motor coupled to the steering wheel. The secondary motor provides the driver with the appropriate resistance and feedback in response to specific user inputs at the steering wheel to mimic the feel of a conventional steering system.

In a steer-by-wire system, a malfunction or failure of a portion of the assembly may impair the ability to steer the vehicle. As a result, it is desirable to provide the assembly with structure for providing at least temporary fail-safe operation. US 2006/0042858 A1 discloses steering apparatus including a steering assembly that includes a handwheel actuator. The handwheel actuator includes a steering column for supporting a steering wheel, a gear mechanism and two motors, each for providing a torque to the steering column.

### SUMMARY

GB 2579374 A discloses a steering column assembly for use with a steer-by-wire hand wheel actuator. This assembly utilises a similar dual motor drive system that comprises first and second motors, each having an output driving a respective output gear. Each output gear drives a first gear which is connected to and configured to rotate a shaft of the steering wheel to provide a sensation of road feel to the driver. The dual motor drive system is used to reduce gear rattle by driving both motors at the same time to apply opposing torques to the steering column. Having two motors also provides for some redundancy in the system.

The HWA imposes a friction on the steering wheel shaft. This friction is mostly comprised of a load-dependent component that increases as the torque transmitted by the gearbox increases. There is also an approximately constant component that is not load-dependent. The total HWA friction is the sum of these two components.

The friction can vary according to the operating temperature of the gearset, wear in the gearset and other factors. It is desirable to measure the amount of friction in the gearbox to allow the general condition of the gearbox over life to be checked, and to adjust an estimate of the gearbox friction.

In accordance with an exemplary arrangement of the present disclosure, there is provided a dual motor drive assembly comprising:
a housing;
a shaft rotatably mounted with respect to the housing;
a first gear connected to and configured to rotate with the shaft;
first and second motors, each having an output driving a respective output gear, the output gears being engaged with the first gear;
a control circuit which is adapted to allocate independent torque demands to each of the first and second motors to cause a net torque to be applied to the shaft, and a processing circuit adapted to estimate the level of load independent mechanical friction of the system by applying torque demands to the two motors that include equal and opposite offset components which provide a net zero torque plus an additional torque component that is applied to the motors to provide an overall non-zero torque to the first gear
in which the processing circuit varies the difference between the motor torques demanded from each motor over a range of values at a time when there are no external inputs to the system and observes the lowest value of the net torque within that range that overcomes the mechanical friction to cause the shaft to rotate at a constant velocity.

The processing circuit may vary the offset torque components over a range and for a plurality of values in that range determine the net torque required to cause the shaft to rotate at a constant velocity, and may be configured to determine the lowest value of torque by extrapolation of the results over the range and hence the load independent friction. Changing the offset torque will introduce a variable load dependent friction alongside the constant load independent friction and extrapolation will provide a more accurate way to determine that constant friction.

Additionally the processing circuit may estimate the load dependent friction value from the net torque values for a given value of offset torque component and subtracting the estimated load independent friction value.

This disclosure provides techniques to measure the constant friction that is present at a time when there are no external inputs on the system and as such it is most likely to be used as part of a power-up or power-down test sequence, but may also be implemented during normal operation (e.g., when the vehicle is in some autonomous mode and the driver is not applying any external torque to the system through a steering wheel).

The two motors are controlled so that the net torque that they impose on the steering shaft via the gearwheel is closely matched to the demand torques, excluding friction effects. The control circuit may be configured to provide scaling for the gear ratio and compensation for factors that can cause a variation in motor outputs such as temperature, ripple torque and the internal dynamics. A net torque may be defined as an instantaneous sum of the two motor torque demands.

The drive assembly may include a controller for estimating the mechanical friction as a function of the identified lowest net torque. For example, information may be stored in a look up table of a memory that maps net torque to mechanical friction.

In a modification, the controller to estimate the mechanical friction may identify the average net torque that is required to overcome the friction as the value which causes the shaft to rotate at a constant angular speed in a first direction, and may identify the average net torque that is required to overcome the friction as the value which causes the shaft to rotate at a constant angular speed in a second direction, where the first direction is not equal to the second direction.

The applicant has appreciated that the friction may be different depending on the direction of rotation of the shaft, so identifying this in both directions may be beneficial. The friction may vary as the shaft is turned so it is desirable to obtain an average over a range of rotation angles.

In a further arrangement, the controller for estimating the friction may cause the shaft to rotate at two or more different speeds and to identify the net torque required to just overcome the friction as the value which maintains those different speeds. This allows an estimate of the viscous friction to be determined which varies as a function of shaft rotational speed.

This additional estimation of viscous friction may also be performed for rotations of the shaft in the two opposing directions.

The assembly includes a motor controller that generates independent control signals for each motor and a drive circuit for each motor that causes a motor torque to be generated in response to the control signals.

The motor controller may be configured as a torque demand based control system in which the torque demands applied to each motor correspond to a target output toque from the motor. The net torque demand may then be increased or decreased whilst monitoring the shaft velocity at each step to identify when the motor speed is constant.

The motor controller can also be configured as an angle control system in which the angle demand is set as a ramp to provide a period of constant velocity operation. In this case, the shaft is forced to operate at a constant speed and the motor net torque will settle automatically at the lowest net torque required to achieve that set velocity.

The first gear may comprise a worm wheel, and each motor may be connected to the worm wheel through a respective output gear comprising a worm gear.

The dual motor drive assembly may comprise a part of a Steer-by-Wire Handwheel actuator assembly for a vehicle.

The motors may be provided with Individual control of each motor with a controller to set the target torque for each motor.

In accordance with another exemplary arrangement of the present disclosure, there is provided a method of determining the friction in a dual motor drive assembly of the kind comprising:
a housing;
a shaft rotatably mounted with respect to the housing;
a first gear connected to and configured to rotate with the shaft;
first and second motors, each having an output driving a respective output gear, the output gears being engaged with the first gear; and
a controller for allocating independent torque demands to each of the first and second motors to cause a net torque to be applied to the shaft,
the method comprising:
applying drive signals to the two motors to cause them to apply torques to the shaft that are in opposition;
varying the difference between the two motor torque levels over a range of values at a time when there are no external inputs to the system and for a range of different offset torque component values so as to vary the net torque applied by the two motors; and
observing the lowest value of the net torque within that range that overcomes the mechanical friction to cause the shaft to turn at a constant velocity.

### BRIEF DESCRIPTION OF DRAWINGS

There will now be described by way of example only one embodiment of the present invention with reference to and as illustrated in the accompanying drawings of which:

FIG. 1 shows an exemplary arrangement of a dual motor drive assembly of the disclosure;

FIG. 2 shows a part of the dual motor drive apparatus of FIG. 1 with the gearbox housing removed to better show the gears and the motor connection to the gears;

FIG. 3 shows another exemplary arrangement of a dual motor drive assembly of the disclosure;

FIG. 4 shows a general arrangement of an electronic control unit which controls the two motors of a dual motor drive assembly of the disclosure;

FIG. 5 shows a layout of a Steer-by-Wire system including a dual motor drive assembly according to the disclosure;

FIG. 6A shows the relationship between the feedback torque demanded and the feedback torque applied for a conventional dual motor drive assembly;

FIG. 6B shows the resultant relationship between the net torque applied in FIG. 6A and a mechanical friction torque generated by an interaction of sliding surfaces in an HWA assembly

FIG. 7 is a schematic of the HWA showing the control circuit and processing circuits;

FIG. 8 is a block diagram showing in more detail the parts of the schematic of FIG. 7 associated with the control of the motors during the calculation of the mechanical friction and imbalance;

FIG. 9 is a plot of the shaft Angle, shaft Velocity and Tdiff demands obtained whilst estimating the mechanical friction and imbalance;

FIG. 10 is a plot showing the relationship between the Friction Measurement and Tdemand set to achieve velocity demand and Tdiff; and

FIG. 11 is a plot showing the relationship between the Tdemand and Tdiff in the region of FIG. 10 that is used for determining the fit where the gradient indicates the load-dependent friction and the offset from zero indicates the “constant” friction.

### DETAILED DESCRIPTION

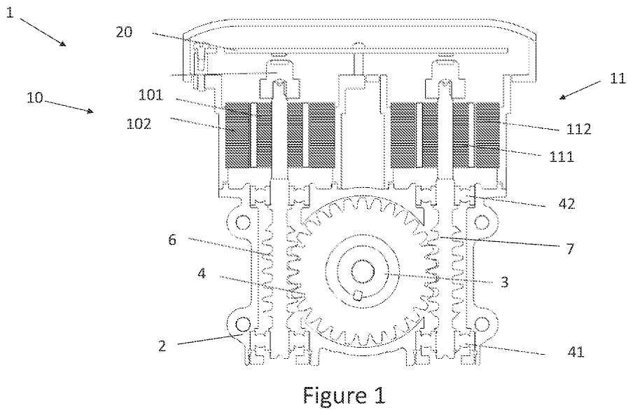

FIG. 1 shows a cross-section of a dual motor drive assembly, suitable for use in a handwheel actuator (HWA) assembly of a vehicle, according to an exemplary arrangement of the disclosure. The drive assembly 1 includes a first motor 10 with a rotor 101 and stator 102, and a second motor 11 with a rotor 111 and stator 112, the first motor 10 being connected to a first worm gear 6 and the second motor 11 being connected to a second worm gear 7. Each worm gear 6, 7 comprises a threaded shaft arranged to engage with a gear wheel 4 connected to a steering column shaft 3 such that torque may be transferred from the worm gears 6, 7 to the gear wheel 4 connected to the steering column shaft. The gear wheel 4 is operatively connected to a driver's steering wheel (not shown) via the steering column shaft 3. In this example, each of the two motors 10, 11 are brushless permanent magnet type motors and each comprise a rotor 101, 111 and a stator 102, 112 having many windings surrounding regularly circumferentially spaced teeth. The arrangement of the two motors 10, 11, the shaft 3, the worm gears 6, 7 and the wheel gear 4 together form a dual motor electrical assembly.

Each of the two motors 10, 11 are controlled by an electronic control unit (ECU) 20. The ECU 20 controls the level of current applied to the windings and hence the level of torque that is produced by each motor 10, 11.

In this example, the two motors 10, 11 are of a similar design and produce a similar level of maximum torque. However, it is within the scope of this disclosure to have an asymmetric design in which one motor 10, 11 produces a higher level of torque than the other 10, 11.

One of the functions of a handwheel actuator (HWA) assembly is to provide a feedback force to the driver to give an appropriate steering feel. This may be achieved by controlling the torque of the motors 10, 11 in accordance with signals from the handwheel actuator (such as column angle) and from other systems in the vehicle (such as vehicle speed, rack angle, lateral acceleration and yaw rate).

The use of two motors 10, 11 is beneficial in eliminating rattle. If a single electric motor were instead used in a torque feedback unit, the motor may be held in locked contact with the gearing by a spring. However, in certain driving conditions the action of a spring is not sufficiently firm, which allows the gears to “rattle” during sinusoidal motions or sharp position changes of the steering column.

Use of two motors 10, 11 which can be actively controlled (as in the present exemplary arrangement) ameliorates the problems associated with use of a single motor. In this arrangement, both motors 10, 11 are controlled by the ECU 20 to provide torque feedback to the steering column and to ensure that the worm shafts 6, 7 of both motors 10, 11 are continuously in contact with the gear wheel 4, in order to minimise rattle. The use of two motors 10, 11 in this way also allows active management of the friction and thereby the feedback force to the driver.

As shown in FIG. 1, the motors 10, 11 are received in and secured to a transversely extending two-part extension of a housing 2. The worm shaft 6, 7 of each motor is supported relative to the housing by two sets of bearings. A first set of bearings 41 supports an first end of each worm shaft 6, 7 distal their respective motor 10, 11 while a second set of bearings 42 supports a second end of each worm shaft 6, 7 proximal their respective motor 10, 11.

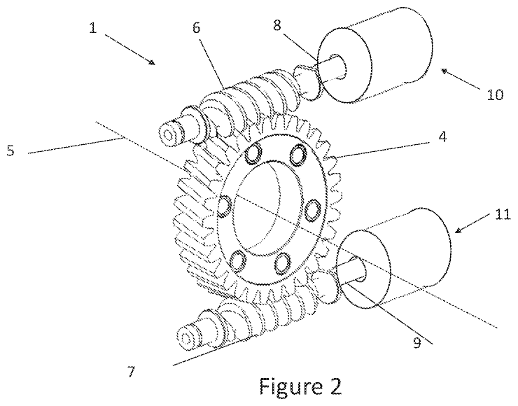

FIG. 2 shows an axis of rotation of the shaft 3 marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to the output shaft 8, 9 of a respective electric motor 10, 11.

The axes of the output shafts 8, 9 of the two motors 10, 11 are arranged perpendicularly to the rotational axis of the shaft 3 and the axes of the two motors may also be inclined with respect to each other, to reduce the overall size of the assembly.

The motors 10, 11 are controlled by the electronic control unit (ECU) 20 such that at low levels of input torque applied to the shaft 3 by the steering wheel, the motors 10, 11 act in opposite directions on the gear wheel 4 to eliminate backlash. At higher levels of input torque applied to the shaft 3 by the steering wheel, the motors 10, 11 act in the same direction on the gear wheel 4 to assist in rotation of the shaft 3. Here, a motor 10, 11 acting in ‘a direction’ is used indicate the direction of torque applied by a motor 10, 11 to the gear wheel 4.

The use of two separate motors 10, 11 which can be controlled in a first operational mode to apply torque in opposite directions to the gear wheel 4 eliminates the need to control backlash with precision components. In addition, the use of two separate motors 10, 11 which can be controlled in a second operational mode to apply torque in the same direction to the gear wheel 4 allows the motors 10, 11 and gear components 4, 6, 7 to be specified at half the rating of the required total system torque, thereby reducing the size and cost of the drive assembly 1.

In the exemplary arrangement shown in FIGS. 1 and 2, the worm shafts 6, 7 engage diametrically opposed portions of a gear wheel 4. The threads of the worm shafts 6, 7 each have the same sense, i.e., they are both left-handed screw threads. The motors 10, 11 are configured such that they lie on the same side of the gear wheel 4 (both motors 10, 11 lie on one side of a virtual plane perpendicular to axes of the worm shafts 6, 7 and passing through the centre point of the gear wheel 4). Considering as an example the perspective shown in FIG. 2, driving both motors 10, 11 clockwise would apply torque in opposite directions to the gear wheel 4, with motor 10 applying a clockwise torque to gear wheel 4 and motor 11 applying an opposing anti-clockwise torque to gear wheel 4.

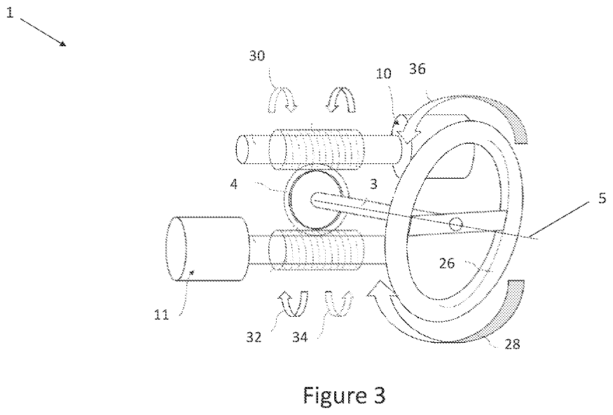

FIG. 3 shows another exemplary arrangement of a dual motor drive assembly, substantially similar to the exemplary arrangement shown in FIGS. 1 and 2 but with different motor positioning.

FIG. 3 shows another exemplary arrangement of a dual motor drive assembly 1 according to an exemplary arrangement of the disclosure. This exemplary arrangement is substantially similar to the exemplary arrangement shown in FIGS. 1 and 2 with the only difference being the positioning of the motors 10, 11. Components and functional units which in terms of function and/or construction are equivalent or identical to those of the preceding exemplary arrangement are provided with the same reference signs and are not separately described. The explanations pertaining to FIG. 1 and FIG. 2 therefore apply in analogous manner to FIG. 3 except for the positioning of the two motors 10, 11.

In FIG. 3 the worm shafts 6, 7 engage diametrically opposed portions of a gear wheel 4 and threads of the worm shafts 6, 7 each have the same sense, i.e., in this example they are both right-handed screw threads. The motors 10, 11 are configured such that they lie on opposing sides of the gear wheel 4 (motor 10 lies on one side of a virtual plane perpendicular to axes of the worm shafts 6, 7 and passing through the centre point of the gear wheel 4 while motor 11 lies on the other side of this virtual plane).

Application of torque by a driver in a clockwise direction indicated by solid arrow 28 results in rotation of the steering wheel 26 and the steering column shaft 3 about the dashed line 5. This rotation is detected by a rotation sensor (not shown). The first motor 10 is then controlled by the ECU 20 to apply torque in the opposite direction as indicated by dashed arrow 30. In a first operational mode, the second motor 11 is actuated by the ECU 20 to apply an offset torque 32 in the opposite direction to the torque 30 of the first motor 10 to reduce gear rattling. In a second operational mode, the second motor 11 is actuated by the ECU 20 to apply a torque 34 in the same direction to the torque 30 of the first motor 10 to increase the feedback torque to the steering column shaft 3. Whether the drive assembly 1 is operated in the first operational mode or in the second operational mode depends on the circumstances, as will be explained below.

The net result of the torques 30, 32, 34 applied by the first and second motors 10, 11 results in an application of a feedback torque to the steering column shaft 3 and steering wheel 26, as indicated by a dashed arrow 36, to provide a sensation of road feel to the driver. In this example, the application of a feedback torque is in the opposite direction to that applied to the steering wheel 26 by the driver. In this way, the “rattle” produced between the worm shafts 6, 7 and the gear wheel 4 can be eliminated or significantly reduced.

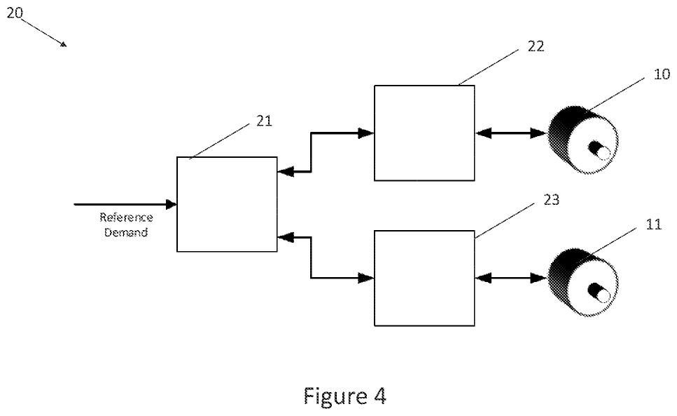

FIG. 4 reveals part of an HWA assembly (80) showing a general arrangement of an electronic control unit (ECU) 20 which controls each of the two motors 10, 11. The ECU 20 may include a hand wheel actuator (HWA) control system 21 as well as a first and second motor controller 22, 23 which control the first and second motors 10, 11 respectively. A reference demand signal is input to the HWA control system 21 which allocates torque demands to each of the first and second motors 10, 11. These motor torque demands are converted to motor current demands and transmitted to the first and second motor controllers 22, 23. Each motor 10, 11 provides operating feedback to their respective motor controller 22, 23. The HWA control system 21 is configured to calculate the magnitude of mechanical friction using the motor torque demands. In another exemplary arrangement, the HWA control system 21 may be implemented by a separate ECU to the first and second motor controller 22, 23.

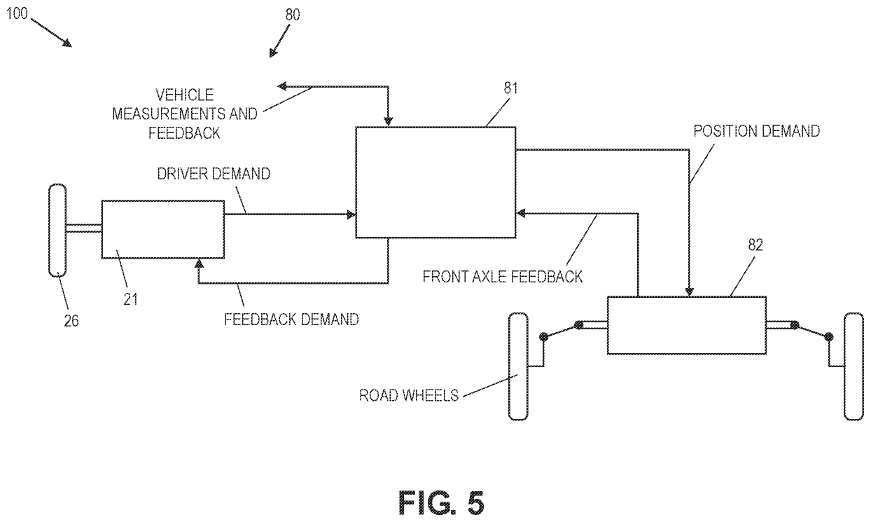

FIG. 5 shows an overall layout of a Steer-by-Wire system 100 for a vehicle including handwheel actuator (HWA) assembly 80 using a dual motor drive assembly 1 according to an exemplary arrangement of the disclosure. The HWA assembly 80 supports the driver's steering wheel 26 and measures the driver demand which is usually the steering angle. A steering controller 81 converts the driver demand into a position demand that is sent to a front axle actuator (FAA) 82. The FAA 82 controls the steering angle of the roadwheels to achieve the position demand. The FAA 82 can feedback operating states and measurements to the steering controller 81.

The steering controller 81 combines the FAA 82 feedback with other information measured in the vehicle, such as lateral acceleration, to determine a target feedback torque that should be sensed by a driver of the vehicle. This feedback demand is then sent to the HWA control system 21 and is provided by controlling the first and second motors 10, 11 with the first and second motor controllers 22, 23 respectively.

FIG. 5 shows the steering controller 81 as physically separate to both the HWA controller 21 and the FAA 82. In another exemplary arrangement, different architectures, where one or more of these components are physically interconnected, may be used within the scope of this disclosure. For example, the functions of the steering controller 81 may be physically implemented in the HWA controller 21, the FAA 82, or another control unit in the vehicle, or some combination of all 3. In another exemplary arrangement, control functions ascribed to the HWA controller 21 and FAA 82 may be partially or totally implemented in the steering controller 81.

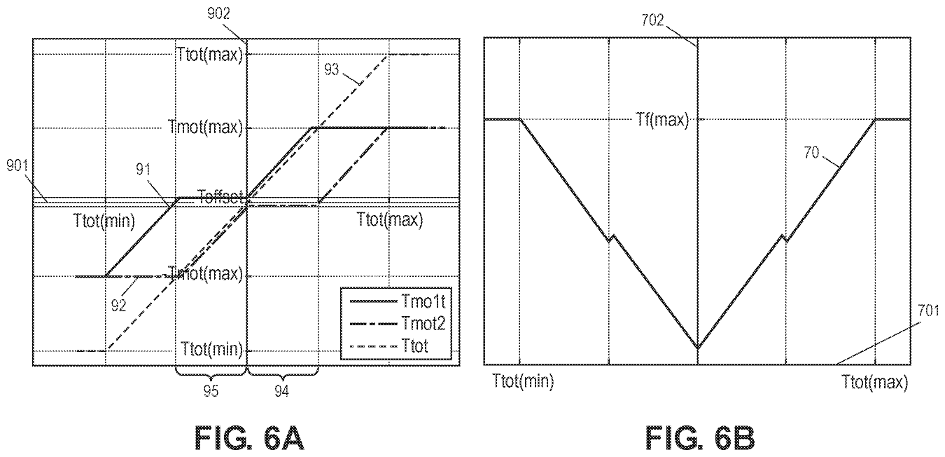

The relationship between the total torque demanded (x-axis) 901 to provide feedback to the driver and the feedback torque applied (y-axis) 902 for a conventional dual motor drive assembly is shown in FIG. 6A.

Solid line 91 represents the torque applied by the first motor 10 while dashed line 92 represents the torque applied by the second motor 11. The net torque applied by the two motors is represented by dashed line 93. In a first torque range 94 where torque is positive, the first motor 10 applies a torque shown by solid line 91 to provide feedback to the steering column shaft 3 and steering wheel 26, while the second motor 11 applies a smaller magnitude torque known as an “offset torque” in the opposite direction to provide an “active” lock to eliminate or reduce transmission rattle. The roles of the motors change depending in which direction the driver is steering. In a second torque range 95 where the torque is negative, the second motor 11 applies a feedback torque 92 to the steering column shaft 3 and the first motor 10 applies a smaller magnitude “offset” torque 91 in the opposite direction.

The resultant relationship between the net torque applied by the two motors 10, 11 (x-axis 701) and mechanical friction torque generated by the interaction of sliding surfaces in an HWA assembly 80 (y-axis 702), is shown in FIG. 6B by solid line 70.

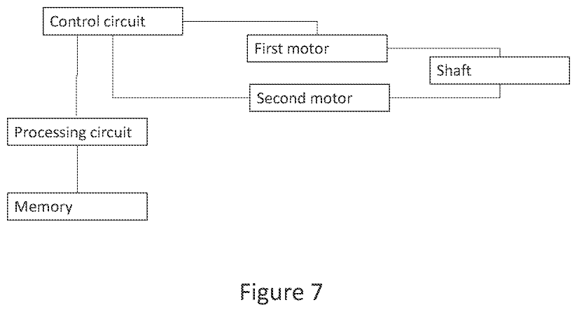

FIG. 7 is a schematic of the HWA showing the control circuit and processing circuits. As can be seen the control circuit generates the motor torque demand and supplies the appropriate drive signals to the two motors. The processing circuit observes the signals within the control circuit and from these estimates the mechanical friction.

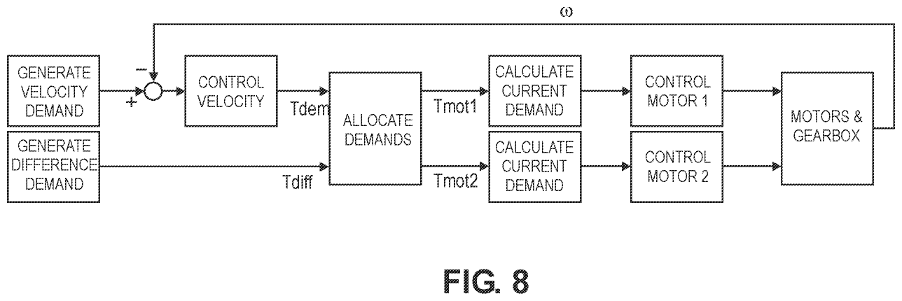

FIG. 8 shows in more detail the parts of the schematic of FIG. 7 associated with the control of the motors during the calculation of the mechanical friction and imbalance. In this example, the motor is controlled using a velocity demand control process in which the input to the control circuit is a demanded velocity. The control circuit sets motor torque demands as required to achieve the demanded velocity based on measurements of the shaft velocity. In an exemplary arrangement, the control circuit may use an angle based control scheme in which a ramped shaft angle is fed to the control circuit. By ramping this linearly from 0 to 360 degrees and repeating the ramp the control circuit will function to make the motor rotate at a constant velocity. Instead of shaft velocity, or in addition, the shaft angle may be fed back to the control circuit.

The assembly is configured to perform a test or set of tests which enable an estimate of the friction in the system to be made.

The tests are performed with the two motors running against each other whilst monitoring the net motor torque that is required to turn the steering wheel against the friction. This is done for a range of opposing offset torque values to allow the constant friction level to be determined by extrapolation from the set of results as explained below.

To understand how the controller estimates the friction consider first that the torque that is applied to the column is:

Tcol=Ngb Tmot1+Ngb Tmot2±Ngb Tloss1±Ngb Tloss2

where
Tcol=column torque
Ngb=gearbox ratio
Tmot1=motor 1 shaft torque
Tmot2=motor 2 shaft torque
Tloss1=torque losses associated with motor 1
Tloss2=torque losses associated with motor 2

The losses act in a direction to oppose the motion of the column.

When moving (i.e., rotating), the torque losses are dominated by electromagnetic losses in the motor and Coulomb friction in the motor and gearbox. Together these have a constant component and a load-dependent component, i.e.

Tloss1=μ|Tmot1|+Tc1

where |Tmot1| is the magnitude of the motor torque Tc1 is the constant component.

The load-dependent loss is determined by the factor μ that depends on the design and materials employed in the worm and wheel gearbox. In practice p will vary with temperature and the condition of the gearbox.

The friction that is load-dependent is:

Tfr=Ngbμ(|Tmot1|+|Tmot2|)

where Tfr is the mechanical friction at the gearbox output.

The two motor torques can be calculated to provide a given column torque demand and a given friction torque demand. One suitable calculation is:

Tmot1=(1/Ngb)(Tdem+Tdiff)/2

Tmot2=(1/Ngb)(Tdem−Tdiff)/2

where Tdem is the demanded net torque. Tdem and Tdiff should be limited so that they do not exceed the maximum motor torque. It is possible to swap this calculation so that Tmot1 and Tmot2 are exchanged.

This disclosure is concerned with the Coulomb friction, not stiction. It is desirable to estimate the friction with the shaft and motors moving.

FIG. 8 shows the components of the control system that can be used to measure the friction

This can include a pre-set velocity demand profile that can contain sections of constant velocity so that the measurements can be made without needing to take account of torque required to accelerate and decelerate the steering wheel.

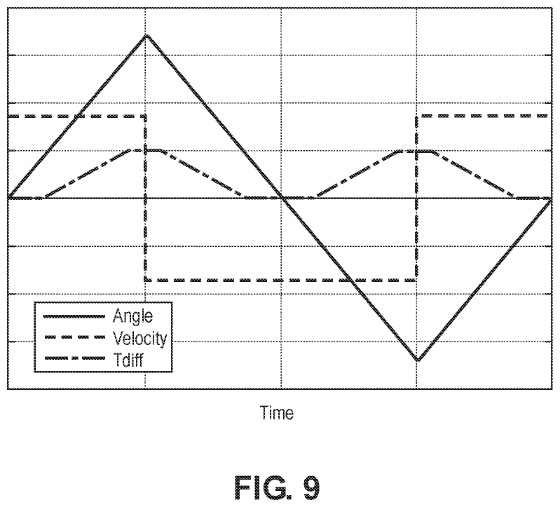

FIG. 9 shows an example of the control demand time histories that can be used. In the example, the measurement is carried out with both positive and negative velocities which allows an average friction to be calculated. Typically the velocity will be relatively low to minimise the movement of the steering wheel; it should be fast enough to ensure an accurate friction measurement can be made.

A pre-set difference torque demand profile. As shown in the example in FIG. 9, this should be synchronised with the velocity demand. In this example, the difference torque is positive.

A velocity control loop calculates the velocity error and sets the net torque demand, Tdem, to control the velocity to match the demand. The velocity controller may include dynamic elements to compensate for the response of the system under control so that the response to the demand is accurate, not resonant and does not “stick-slip” in the presence of stiction.

The difference torque demand and the net torque demand are used to allocate the torque demands to the two motors according to the calculation given above.

Each of the motors is controlled to meet the torque demand. Typically, the torque demand is converted to a motor current demand and the motor currents are controlled with a closed-loop controller. It is expected that the motor controller bandwidth and accuracy will be adequate so that the controller errors are low compared to the magnitude of the friction torque that is being estimated.

Each motor transmits torque into the gearbox and the attached components, most notably the steering wheel.

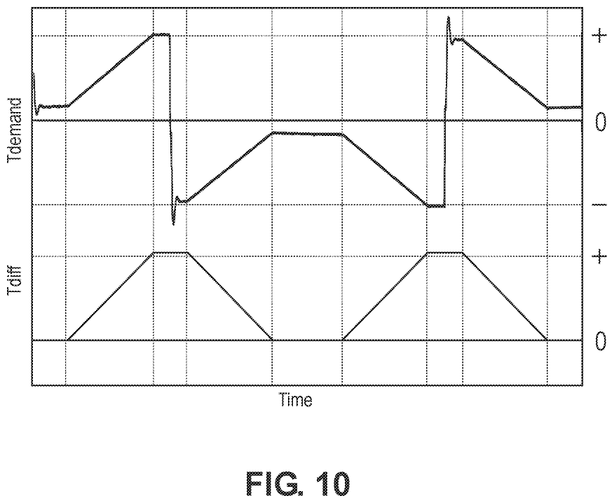

This control system is not necessarily the same as the control system that is normally used to operate the HWA. The control system in FIG. 8 is operated to allow the time profiles shown in FIG. 9 to be imposed. During this time the torque demand, Tdem, is periodically recorded. The description below assumes that a continuous record is available but it is possible to record a small number samples at important points in the test to achieve a similar result. FIG. 10 shows examples of measured signals against time.

The acquired data can be analysed to determine the load-dependent friction. This is done assuming that the torque required to maintain the constant velocity is mostly required to overcome the friction in the HWA components. The example in FIG. 10 shows that the net demanded torque, Tdem, has some transients that are required to accelerate or decelerate the HWA. In other periods during the test, Tdiff is ramped up and down and it can be seen that Tdem is varying in a linear fashion.

As explained above, the torque applied to the column includes the frictional loss, and the frictional loss depends on the difference torque.

Tmot1=(1/Ngb)(Tdem+Tdiff)/2

Tmot2=(1/Ngb)(Tdem−Tdiff)/2

The Coulomb friction in the HWA consists of a constant component and a load-dependent component. The friction magnitude is given by

Tf=μc+μ(|Ngb Tmot1|+|Ngb Tmot2|)

where Tf=total friction, μc=constant friction, μ=friction coefficient of gearbox, Ngb is the gearbox ratio and |.| denotes the absolute value.

At the time periods where the torque applied to the column is largely overcoming the friction, we have

Tdem≈Tf sgn(w)

By using the expression for the torque allocation, this can be rewritten as

Tdem≈(μc+μTdiff)sgn(w)

In the example given, the operation is predominantly in two quadrants so this can be simplified to

|Tdem|≈(μc+μTdiff)

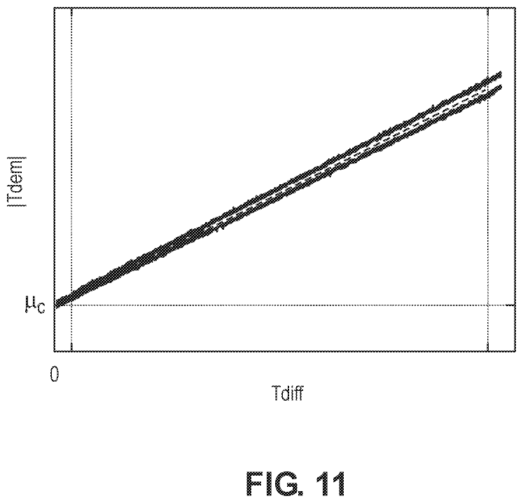

This example is plotted FIG. 11 which shows the measured variables plotted against each other. The figure shows a linear fit that gives the estimate of the constant friction (the offset) and the load-dependent friction (the slope). A practical implementation may only measure a few points and use these to find the average slope and offset.

Once the estimated values of pc and p have been obtained, they can be used to check the condition of the HWA. This can be done by comparison to reference values, or by checking the trend of measurements taken on different journeys or by another suitable process.

The estimated values of pc and p can also be used for a real-time friction compensation algorithm.

1. A dual motor drive assembly comprising:
a housing;
a shaft rotatably mounted with respect to the housing;
a first gear connected to and configured to rotate with the shaft;
first and second motors, each having an output driving a respective output gear, the output gears being engaged with the first gear;
a control circuit configured to allocate independent torque demands to each of the first and second motors to cause a net torque to be applied to the shaft, and
a processing circuit configured to estimate the level of mechanical friction of the system by applying torque demands to the two motors that include equal and opposite offset components which provide a net zero torque plus an additional torque component that is applied to the motors to provide an overall non-zero torque to the first gear,
in which the processing circuit varies the difference between the motor torques demanded from each motor over a range of values at a time when there are no external inputs to the system and observes the lowest value of the net torque within that range that overcomes the mechanical friction to cause the shaft to rotate at a constant velocity.

2. The dual motor drive assembly of claim 1, wherein the processing circuit is configured to vary offset components over the range and, for a plurality of values in that range, determine the net torque required to cause the shaft to rotate at a constant velocity.

3. The dual motor drive assembly of claim 2, wherein the processing circuit is configured to estimate a load dependent friction value from net torque values for a given value of offset component and subtract the estimated load independent friction value.

4. The dual motor drive assembly of claim 1, wherein the the processing circuit is configured to measure the constant friction that is present at a time when there are no external inputs on the system.

5. The dual motor drive assembly of claim 1, wherein the two motors are controlled so that the net torque that they impose on the shaft is matched to the demand torques, excluding friction effects, optionally wherein the control circuit is configured to provide scaling for a gear ratio and/or compensation for one or more factors that can cause a variation in motor outputs including: temperature, ripple torque and internal dynamics.

6. The dual motor drive assembly of claim 1, wherein the processing circuit is configured to estimate the mechanical friction as a function of the identified lowest net torque optionally utilising a look up table of a memory that maps net torque to mechanical friction.

7. The dual motor drive assembly of claim 6, wherein the processinq circuit is configured to identify the average net torque that is required to overcome the friction as the value which causes the shaft to rotate at a constant angular speed in a first direction, and identifies the average net torque that is required to overcome the friction as the value which causes the shaft to rotate at a constant angular speed in a second direction, where the first direction is not equal to the second direction.

8. The dual motor drive assembly of claim 6, wherein the processinq circuit is configured to cause the shaft to rotate at two or more different speeds and to identify the net torque required to just overcome the friction as the value which maintains those different speeds and determining an estimate of a viscous friction which varies as a function of shaft rotational speed.

9. The dual motor drive assembly of claim 8, wherein the processinq circuit is configured to determine the estimate of viscous friction for rotations of the shaft in two opposing directions.

10. The dual motor drive assembly of claim 1, further including a motor controller that generates independent control signals for each of the two motors and a drive circuit for each motor that causes a motor torque to be generated in response to the control signals.

11. The dual motor drive assembly of claim 10, wherein the motor controller is configured as a torque demand-based control system in which the torque demands applied to each motor correspond to a target output toque from that motor and wherein the dual motor drive assembly is configured to increase or decrease a net torque demand whilst monitoring the shaft velocity at each step to identify when a motor speed is constant.

12. The dual motor drive assembly of claim 10, wherein the motor controller is configured as an angle control system in which the angle demand is set as a ramp to provide a period of constant velocity operation.

13. The dual motor drive assembly of claim 1, wherein the first gear comprises a worm wheel, and each motor is connected to the worm wheel through a respective output gear comprising a worm gear.

14. The dual motor drive assembly of claim 1, wherein the dual motor drive assembly comprises a part of a Steer-by-Wire Handwheel actuator assembly for a vehicle.

15. A method of determining the friction in a dual motor drive assembly, the method comprising:
applying drive signals to two motors to cause them to apply torques to a shaft that are in opposition;
varying the difference between the two motor torque levels over a range of values at a time when there are no external inputs to the system and for a range of different offset torque component values so as to vary the net torque applied by the two motors; and
observing the lowest value of the net torque within that range that overcomes the mechanical friction to cause the shaft to turn at a constant velocity.
